(19) United States
(12) Patent Application Publication
(10) Pub. No.: US 2016/0072428 A1
(43) Pub. Date: Mar. 10, 2016

(54) SOLAR CELL SUPPORT ASSEMBLY

(71) Applicant: BYD COMPANY LIMITED, Shenzhen, Guandong (CN)

(72) Inventors: GUANGDI LI, Shenzhen (CN); YAOQIN HUANG, Shenzhen (CN); HONGBIN WANG, Shenzhen (CN); LONG HE, Shenzhen (CN); JIAOLIAN XU, Shenzhen (CN); YONG XIE, Shenzhen (CN)

(21) Appl. No.: 14/785,515

(22) PCT Filed: May 14, 2014
(86) PCT No.: PCT/CN2014/077460

§ 371 Date: Oct. 19, 2015

(30) Foreign Application Priority Data
May 14, 2013 (CN) 201320258480.2

(51) Int. Cl. H02S 20/32

(52) U.S. Cl. CPC H02S 20/32

(57) ABSTRACT

A solar cell support assembly includes: a plurality of support bases; a rotation shaft rotatably supported on the support bases; a frame connected to the rotation shaft to rotate with the rotation shaft and swung with respect to the rotation shaft in a pitch direction to change a pitch angle formed between the rotation shaft and the frame, the frame defining a first portion located above the rotation shaft and a second portion located below the rotation shaft; and a adjusting device disposed between the frame and the rotation shaft to adjust the pitch angle.

### CROSS-REFERENCE TO RELATED APPLICATION

This application claims priority to, and benefits of Chinese Patent Application Serial No. 201320258480.2, filed with the State Intellectual Property Office of China, on May 14, 2013, the entire content of which is incorporated herein by reference.

### FIELD

Exemplary embodiments of the present disclosure relate generally to a solar cell field and, more particularly, to a solar cell support assembly.

### BACKGROUND

A solar cell support assembly in the related art includes two types: a fixed-type support assembly and a tracking-type support assembly. The tracking-type support assembly is widely used, because it may enlarge the effective light absorption area, thus increasing the daily electric energy production of the solar cell.

With the conventional tracking-type support assembly, one pushrod is driven by a driving device to rotate the solar cell according to a position of the sun. The solar cell is mounted on a frame disposed above a rotation shaft frame, so that a center of gravity of the solar cell and the frame is higher than the center of the gravity of the rotation shaft. Accordingly, the moment arm for rotating the rotation shaft and the torsion of the rotation shaft are increased, so that a large size and strength of the rotation shaft is required, so that the cost is high, and a powerful driving device is necessary, and the energy consumption is also high.

### SUMMARY

Embodiments of the present disclosure seek to solve at least one of the problems.

According to an embodiment of the present disclosure, a solar cell support assembly with a center of gravity of the solar cell and the frame close to a center of the gravity of the rotation shaft is provided. The solar cell support assembly includes: a plurality of support bases; a rotation shaft rotatably supported on the support bases; a frame for mounting solar cells thereon, connected to the rotation shaft to rotate with the rotation shaft and swung with respect to the rotation shaft in a pitch direction to change a pitch angle formed between the rotation shaft and the frame, the frame defining a first portion located above the rotation shaft and a second portion located below the rotation shaft; and an adjusting device connected between the frame and the rotation shaft to adjust the pitch angle.

In some embodiments, the area of the first portion is at least a quarter of that of the second portion.

In some embodiments, the area of the first portion is equal to that of the second portion.

In some embodiments, the frame includes: an upper beam disposed above the rotation shaft; a lower beam disposed below the rotation shaft; and a connecting rod connected with the upper beam and the lower beam, and pivotably connected to the rotation shaft.

In some embodiments, the frame includes a first connecting member fixed on the rotation shaft.

In some embodiments, the connecting rod is pivotably connected to the first connecting member fixedly disposed on the rotation shaft.

In some embodiments, the frame further includes an upper supporting bracket configured to support the upper beam and a lower supporting bracket configured to support the lower beam, and the adjusting device is connected to the upper supporting bracket and the lower supporting bracket respectively to control the pitch angle formed between the rotation shaft and the frame.

In some embodiments, the upper supporting bracket includes an upper-left supporting rod, an upper-middle supporting rod and an upper-right supporting rod, first ends of the upper-left supporting rod and the upper-right supporting rod are connected to the upper-middle supporting rod, the second ends of the upper-left supporting rod and the upper-right supporting rod are connected to the upper beam, the upper-middle supporting rod is connected to the upper beam and is adjustably connected to the rotation shaft via the adjusting device, and first end of the connecting rod is connected to the upper-middle supporting rod; wherein the lower supporting bracket includes a lower-left supporting rod, a lower-middle supporting rod and a lower-right supporting rod, first ends of the lower-left supporting rod and the lower-right supporting rod are connected to the lower-middle supporting rod respectively, second ends of the lower-left supporting rod and the lower-right supporting rod are connected to the lower beam, the lower-middle supporting rod is connected to the lower beam and adjustably connected to the rotation shaft via the adjusting device, and second end of the connecting rod is connected to the lower-middle supporting rod.

In some embodiments, the adjusting device includes: a first connecting piece and a second connecting piece disposed on the upper-middle supporting rod and spaced with each other in a length direction of the upper-middle supporting rod; a first adjusting member connected to the rotation shaft and at least one of the first connecting piece and second connecting pieces to adjust the pitch angle; and a second adjusting member connected to the rotation shaft and to the lower-middle supporting rod adjustably so as to adapt to a change of the pitch angle formed between the rotation shaft and the frame.

In some embodiments, each of the first connecting member and second connecting members is configured as a U-shaped bolt, and the rotation shaft passes through the first and second connecting members, respectively.

In some embodiments, the frame includes: an upper beam disposed above the rotation shaft; an upper supporting bracket connected to the upper beam and pivotably connected to the rotation shaft via the adjusting device to adjust the pitch angle; a second connecting member fixedly disposed on the rotation shaft; a middle beam disposed above the rotation shaft and pivotably connected to the second connecting member; a lower supporting bracket pivotably connected to the second connecting member; and a lower beam disposed below the rotation shaft and connected to the lower supporting bracket.

In some embodiments, the upper supporting bracket includes an upper-left supporting rod, an upper-middle supporting rod and an upper-right supporting rod, one end of the upper-left supporting rod and one end of the upper-right supporting rod are connected to the upper-middle supporting rod, the other end of the upper-left supporting rod and the other end of the upper-right supporting rod are connected to the upper beam, the upper-middle supporting rod is adjustably connected to the rotation shaft via the adjusting device.

In some embodiments, a first connecting hole and a second connecting hole are formed in the upper-middle supporting rod and spaced with each other in a length direction of the upper-middle supporting rod, the adjusting device includes a third adjusting member fixedly disposed on the rotation shaft and defining a coupling hole corresponding to one of the first connecting hole and second connecting holes, and a bolt disposed in the third adjusting member via the coupling hole, the bolt is connected to one of the first connecting hole and the second connecting holes to adjust the pitch angle formed between the rotation shaft and the frame.

In some embodiments, the lower supporting bracket includes a lower-left supporting rod, a lower-middle supporting rod and a lower-right supporting rod, first ends of the lower-left supporting rod and the lower-right supporting rod are connected to the lower-middle supporting rod respectively, second ends of the lower-left supporting rod and the other end of the lower-right supporting rod are connected to the lower beam, the lower-middle supporting rod is pivotably connected to the second connecting member and connected to the lower beam.

With disposing a first portion of the frame above the rotation shaft and a second portion of the frame below the rotation shaft, the center of gravity of the solar cells and the frame is lowered and close to the center of the gravity of the rotation shaft. Thus the moment arm of the rotation shaft is decreased, and the torsion of the rotation shaft is lowered, so that a radial size and strength of the rotation shaft can be reduced to save the cost, and the energy consumption of the solar cell support assembly can be decreased. Moreover, the adjusting device can easily control the pitch angle between the frame and the rotation shaft, so as to adapt to the heights of sun in different seasons.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, among which:

FIG. 1 is a perspective view of a solar cell support assembly according to one embodiment of the present disclosure;

FIG. 2 is an enlarged view of circle A in FIG. 1;

FIG. 3 is perspective view of the upper beam, the upper supporting bracket and the rotation shaft as shown in FIG. 1;

FIG. 4 is a side view of solar cell support assembly as shown in FIG. 1, wherein the first adjusting member is connected to the first connecting piece;

FIG. 5 is a side view of solar cell support assembly as shown in FIG. 1, wherein the first adjusting member is connected to the second connecting piece;

FIG. 6 is a perspective view of a solar cell support assembly according to another embodiment of the present disclosure;

FIG. 7 is an enlarged view of circle B in FIG. 6;

FIG. 8 is perspective view of the upper beam, the upper supporting bracket and the rotation shaft as shown in FIG. 6;

FIG. 9 is a side view of solar cell support assembly as shown in FIG. 6, wherein the third adjusting member is connected to the first connecting hole; and

FIG. 10 is a side view of solar cell support assembly as shown in FIG. 6, wherein the third adjusting member is connected to the second connecting hole.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

It would be appreciated by those skilled in the related art that phraseology and terminology used herein with reference to device or element orientation (such as, terms like “longitudinal”, “lateral”, “up”, “down”, “front”, “rear”, “left”, “right”, “vertical”, “horizontal”, “top”, “bottom”, “inside”, “outside”) are only used to simplify description of the present disclosure, and may not indicate or imply that the device or element referred to must have or operated in a particular orientation. They may not be seen as limits to the present disclosure.

In the description, terms concerning attachments, coupling and the like, such as “connected” and “interconnected”, refer to a relationship in which structures are secured or attached to one another through mechanical or electrical connection, or directly or indirectly through intervening structures, unless expressly described otherwise. Specific implications of the above phraseology and terminology may be understood by those skilled in the art according to specific situations.

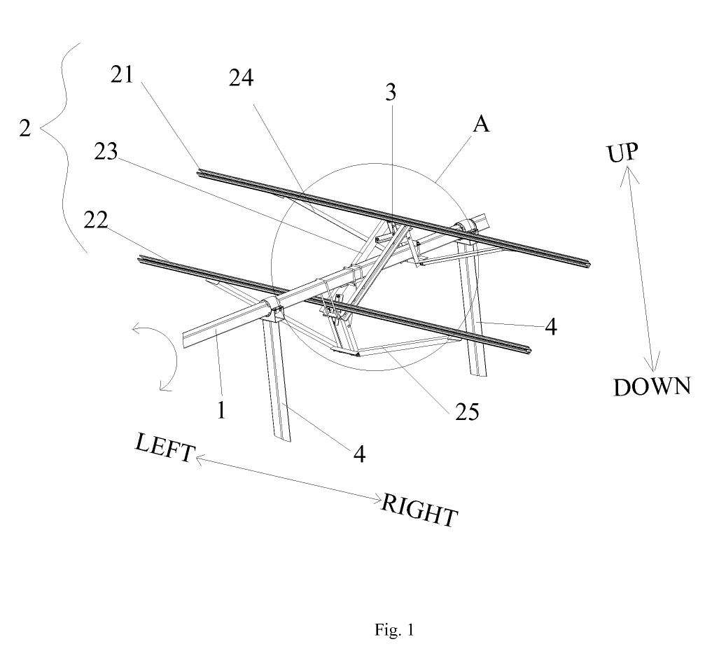

As shown in FIG. 1 to FIG. 10, a solar cell support assembly is provided. The solar cell support assembly includes a rotation shaft 1, a frame 2, an adjusting device and support bases 4. The rotation shaft 1 is connected to the driving device and rotatably supported on the support bases 4, so that the rotation shaft 1 is driven to rotate on the support bases 4 in the latitude direction.

The frame 2 is configured to mount the solar cell 7 thereon and connected to the rotation shaft 1 to rotate with the rotation shaft 1. Moreover, the frame 2 is swung with respect to the rotation shaft 1 in a pitch direction, i.e., the longitude direction. Thus, the solar cell supporting assembly can track a position of the sun via the rotation of the rotation shaft 1 and is adjustable in the pitch direction according to different seasons, which keep the effective light absorption area of solar cells always to the fullest extent.

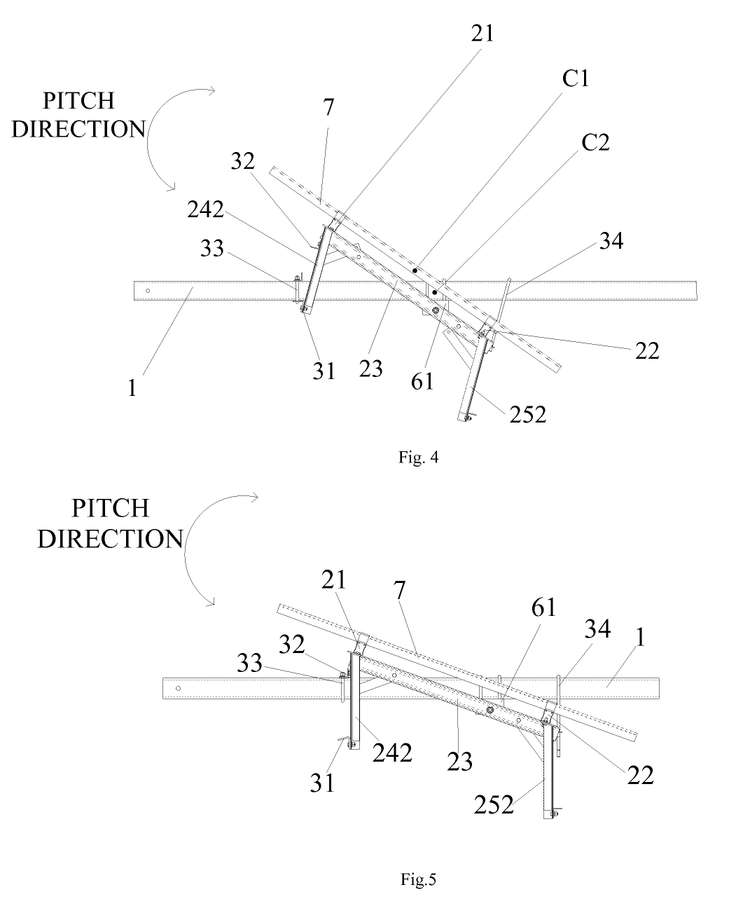

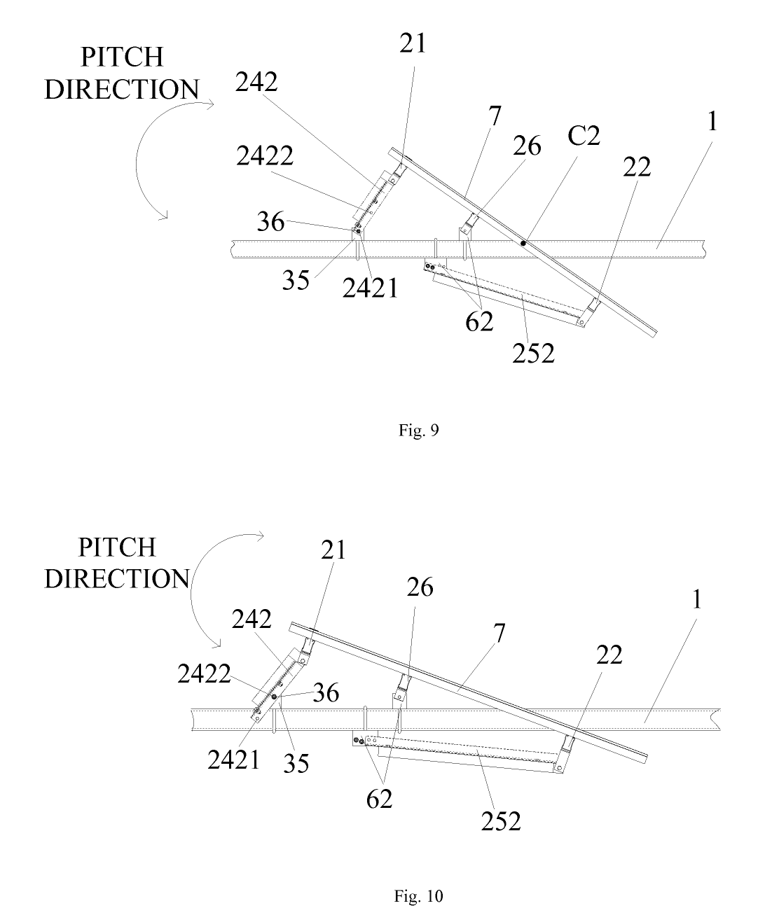

The frame 2 has an upper portion disposed above the rotation shaft 1 and a lower portion disposed below the rotation shaft 1. More specifically, the upper portion means the area between an upper edge of the frame 2 and the rotation shaft 1, and the lower portion means the area between a lower edge of the frame 2 and the rotation shaft 1. Thus, when the solar cell 7 is mounted on the frame 2, the center of gravity C1 of the solar cell 7 and the frame 2 is lowered to be close to or coincide with the center of gravity C2 of the rotation shaft 1, as shown in FIG. 4 and FIG. 9. The adjusting device is connected between the frame 2 and the rotation shaft 1, so as to adjust the pitch angle between the frame 2 and the rotation shaft 1 in the pitch direction.

By disposing a first portion of the frame 2 above the rotation shaft 1 and a second portion of the frame 2 below the rotation shaft 1, the center of gravity C1 of the solar cell 7 and the frame 2 is lowered and is close to the center of the gravity C2 of the rotation shaft 1. Thus, the moment arm for rotating the rotation shaft 1 and the torsion of the rotation shaft 1 is decreased, so that the size and strength of the rotation shaft 1 can be reduced to save the cost, and the energy consumption of the solar cell support assembly can also be decreased. Moreover, the adjusting device can easily control the pitch angle between the frame 2 and the rotation shaft 1, so as to adapt to the heights of sun in different seasons.

In order to ensure that the C1 is sufficiently close to C2, the area of the first portion of the frame 2 may be at least a quarter of that of the second portion of the frame 2, more particularly, the area of the first portion of the frame 2, may be equal to that of the second portion of the frame 2.

In some embodiments, as shown in FIGS. 1-5, the frame 2 includes an upper beam 21 disposed above the rotation shaft 1, a lower beam 22 disposed below the rotation shaft 1, and a connecting rod 23 pivotably connected to the rotation shaft 1. The upper beam 21 and the lower beam 22 are fixedly connected via the connecting rod. The area between an upper edge of the upper beam 21 and the rotation shaft 1 is the first portion, and the area between a lower edge of the lower beam 22 and the rotation shaft 1 is the second portion.

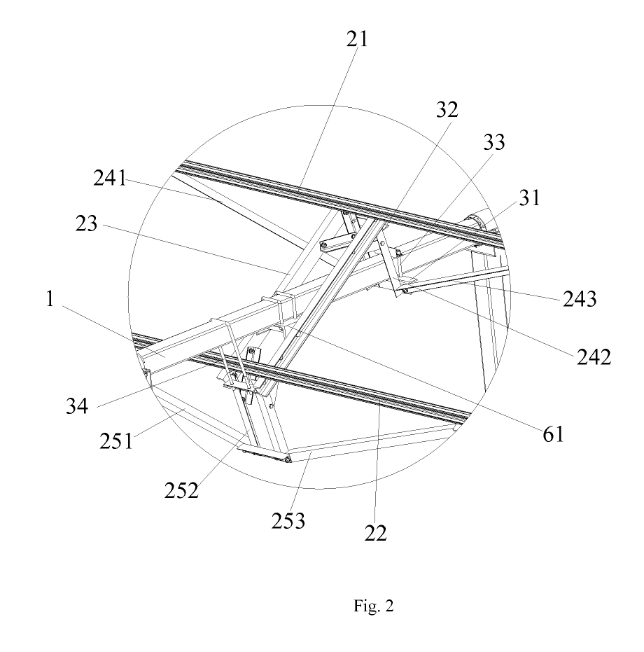

As shown in FIG. 2, a first connecting member 61 is fixedly disposed on the rotation shaft 1 and pivotably connected to the connecting rod 23, so that the rotation of the connecting rod 23 allows the frame 2 to swing with respect to the rotation shaft 1 in the pitch direction.

The frame may further includes an upper supporting bracket 24 configured to support the upper beam 21 and a lower supporting bracket 25 configured to support the lower beam 22, and the adjusting device is connected to the upper supporting bracket 24 and the lower supporting bracket 25 respectively to control the pitch angle between the frame 2 and the rotation shaft 1.

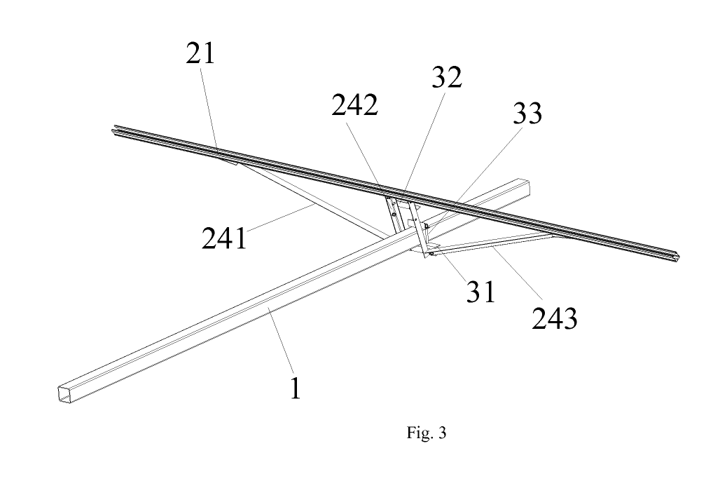

As shown in FIG. 3, the upper supporting bracket 24 includes an upper-left supporting rod 241, an upper-middle supporting rod 242 and an upper-right supporting rod 243.

First ends (i.e., lower ends) of the upper-left supporting rod 241 and upper-right supporting rod 243 are connected to the upper-middle supporting rod 23 respectively, and second ends (i.e., upper ends) of the upper-left supporting rod 241 and upper-right supporting rod 243 are connected to the upper beam 21 respectively. The upper-middle supporting rod 242 is connected to the upper beam 21 and adjustably connected to the rotation shaft 1 via the adjusting device. In other words, a connection point between the upper-middle supporting rod 242 and the rotation shaft 1 can be adjustable by the adjusting device. First end (i.e., upper end) of the connecting rod 23 is connected to the upper-middle supporting rod 242, so as to connect to the upper beam 21.

The lower supporting bracket 25 includes a lower-left supporting rod 251, a lower-middle supporting rod 252 and a lower-right supporting rod 253.

First ends (i.e., lower ends) of the lower-left supporting rod 251 and lower-right supporting rod 253 are connected to the lower-middle supporting rod 252, second ends (i.e., upper ends) of the lower-left supporting rod 251 and lower-right supporting rod 253 are connected to the lower beam 22. The lower-middle supporting rod 252 is connected to the lower beam 22 and adjustably connected to the rotation shaft 1 via the adjusting device. In other words, a connection point between the lower-middle supporting rod 252 and the rotation shaft 1 can be adjustable by the adjusting device. Second end (i.e., lower end) of the connecting rod 23 is connected to the lower-middle supporting rod 252, so as to connect to the lower beam 22.

As shown in FIG. 2, the adjusting device includes: a first connecting piece 31, a second connecting piece 32, a first adjusting member 33 and a second adjusting member 34.

The first connecting piece 31 and second connecting piece 32 are disposed on the upper-middle supporting rod 242 and spaced with each other in a length direction of the upper-middle supporting rod 242, i.e., first connecting piece 31 and second connecting piece 32 are disposed at different heights in an up-down direction. For instance, the first connecting piece 31 is located below the second connecting piece 32.

The first adjusting member 33 is connected to the rotation shaft 1 and engaged with at least one of the first connecting piece 31 and the second connecting piece 32 to adjust the pitch angle. Further, the first adjusting member 33 changes the pitch angle by being selectively connected to the first connecting piece 31 or the second connecting piece 32 which are located at different heights.

The second adjusting member 34 is connected to the rotation shaft 1, and the lower-middle supporting rod 252 is adjustably connected to the second adjusting member 34 to adapt to a change of the pitch angle.

Each of the first connecting member 33 and the second connecting member 34 may be a U-shaped bolt, the first connecting member 33 is connected to the first connecting piece 31 or the second connecting piece 32 via a nut. The lower-middle supporting rod 252 is connected to different portions of the second adjusting member 34 via a nut. In other words, the lower-middle supporting rod 252 can be connected to the portions of the second connecting member 34 at different heights in the up-down direction by the nuts. Thus, it is adapted to the change of the pitch angle, when the pitch angle is adjusted by the connection between the first connecting member 33 and the first connecting piece 31 or between the first connecting member 33 and the second connecting piece 32,

The rotation shaft 1 passes through the first and second connecting members, so that the rotation shaft 1 can cooperate with closed ends of the U-shaped first and second connecting members 33 and 34.

As shown in FIG. 4, when the first adjusting member 33 is engaged with the first connecting piece 31, the frame 2 is capable of swinging with respect to the rotation shaft 1 to a position in which the pitch angle is about 35°, so that it is advantageous for enlarging the effective light absorption area of the solar cell in winter season.

As shown in FIG. 5, when the first adjusting member 33 is engaged with the second connecting piece 32, the frame 2 is capable of swinging with respect to the rotation shaft 1 to a position in which the pitch angle is about 20°, so that it is advantageous for enlarging the effective light absorption area of the solar cell in summer season.

It will be appreciated by those skilled in the related art that there is no limitation for the number of the connecting pieces, and the number of the connecting pieces may be more than two according to actual needs.

Thus, the torsion of the rotation shaft 1 is decreased, and the adjusting device can easily adjust the pitch angle between the frame 2 and the rotation shaft 1, so as to adapt to the heights of sun in different seasons.

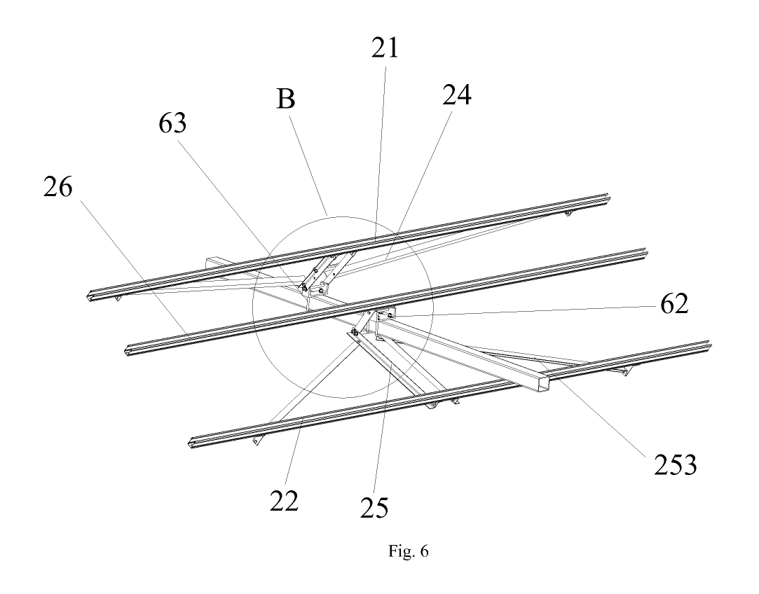

In some embodiments, as shown in FIGS. 6-10, the frame 2 includes: an upper beam 21, an upper supporting bracket 24, a second connecting member 62, a middle beam 26, a lower beam 22 and a lower supporting bracket 25.

More particularly, the upper beam 21 and the middle beam 26 are disposed above the rotation shaft 1 and the upper beam 21 is above the middle beam 26. The lower beam 22 is disposed below the rotation shaft 1. The area between an upper edge of the upper beam 21 and the rotation shaft 1 is the first portion and located above the rotation shaft 1, and the area between a lower edge of the lower beam 22 and the rotation shaft 1 is the second portion and located below the rotation shaft 1, so that the center of gravity of the solar cell and frame 2 and the center of gravity of the rotation shaft 1 can coincide substantially at a point C3, as shown in FIG. 9.

The upper supporting bracket 24 is connected to the upper beam 21 and is pivotably connected to the rotation shaft 1 via the adjusting device to adjust the pitch angle. The second connecting member 62 is fixed on the rotation shaft 1. The middle beam 26 is pivotably connected to the second connecting member 62, and the lower supporting bracket 25 is pivotably connected to the second connecting member 62 and connected to the lower beam 22.

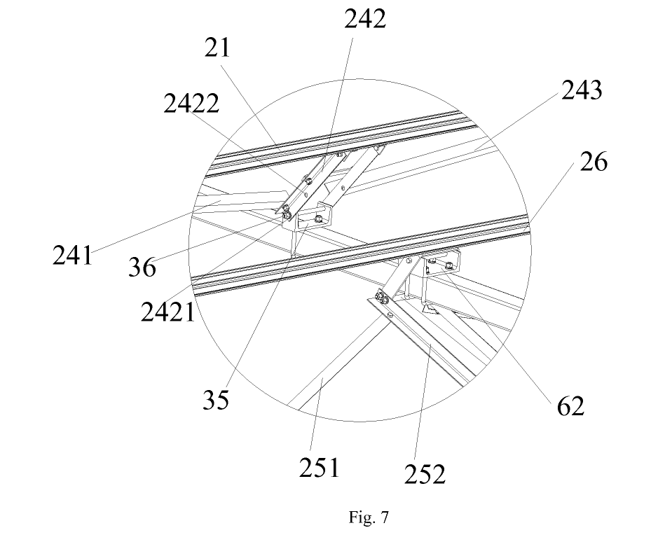

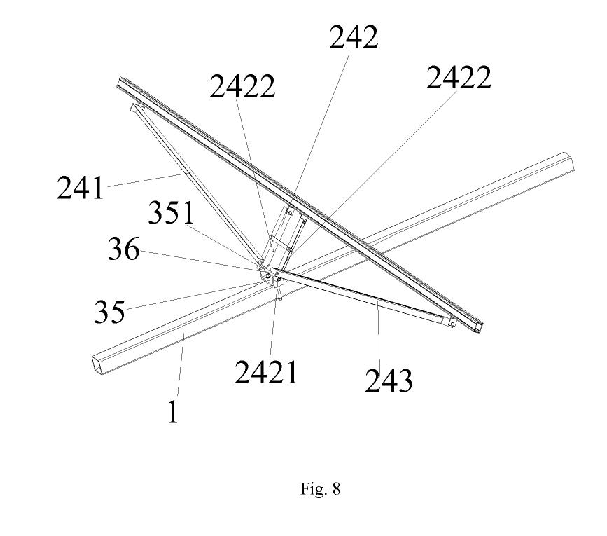

As shown in FIG. 7 and FIG. 8, the upper supporting bracket 24 includes an upper-left supporting rod 241, an upper-middle supporting rod 242 and an upper-right supporting rod 243.

First ends (i.e., lower ends) of the upper-left supporting rod 241 and upper-right supporting rod 243 are connected to the upper-middle supporting rod 242, and second ends (i.e., upper ends) of the upper-left supporting rod 241 and upper-right supporting rod 243 are connected to the upper beam 21, respectively. The upper-middle supporting rod 242 is adjustably connected to the rotation shaft 1 via the adjusting device.

A first connecting hole 2421 and a second connecting hole 2422 are formed on the upper-middle supporting rod 242 and spaced with each other in the length direction of the upper-middle supporting rod 242. For example, the first connecting hole 2421 is below the second connecting hole 2422.

Correspondingly, the adjusting device includes a third adjusting member 35 fixed on the rotation shaft 1 via a bolt 36. The third adjusting member 35 has a coupling hole 351 corresponding to one of the first connecting hole 2421 and second connecting hole 2422. The bolt 36 is configured to dispose in the third adjusting member 35 via the coupling hole 351 and is cooperated with one of the first connecting hole 2421 and the second connecting hole 2422, so as to adjust the pitch angle.

The lower supporting bracket 25 includes a lower-left supporting rod 251, a lower-middle supporting rod 252 and a lower-right supporting rod 253.

First ends (i.e., upper ends) of the lower-left supporting rod 251 and lower-right supporting rod 253 are connected to the lower-middle supporting rod 252, second ends (i.e., lower ends) of the lower-left supporting rod 251 and lower-right supporting rod 253 are connected to the lower beam 22. The lower-middle supporting rod 252 is pivotably connected to the second connecting member 62 and connected to the lower beam 22.

As shown in FIG. 9, when the bolt 36 is cooperated with the first connecting hole 2421, the middle beam 26 and the lower beam 22 are correspondingly swung with respect to the rotation shaft 1 to a position in which the pitch angle is about 35°, so that it is advantageous for enlarging the effective light absorption area of the solar cell in winter season.

As shown in FIG. 10, when the bolt 36 is cooperated with the second connecting hole 2422, the middle beam 26 and the lower beam 22 are correspondingly swung with respect to the rotation shaft 1 to a position in which the pitch angle is about 20°, so that it is advantageous for enlarging the effective light absorption area of the solar cell in summer season.

It will be appreciated by those skilled in the related art that there is no limitation for the number of the connecting holes, and the number of the connecting holes may be more than two according to actual needs.

Thus, the torsion of the rotation shaft 1 is decreased, and the adjusting device can easily adjust the pitch angle between the frame 2 and the rotation shaft 1, so as to adapt to height of sun in different seasons.

The FIGS. 1-10 are just schematic diagrams. Although explanatory embodiments have been shown and described, it would be appreciated by those skilled in the art that the above embodiments may not be construed to limit the present disclosure, and changes, alternatives, and modifications can be made in the embodiments without departing from spirit, principles and scope of the present disclosure.

1. A solar cell support assembly, comprising:
a plurality of support bases;
a rotation shaft rotatably supported on the support bases;
a frame for mounting solar cells thereon, connected to the rotation shaft to rotate with the rotation shaft and capable of swinging with respect to the rotation shaft in a pitch direction to change a pitch angle formed between the rotation shaft and the frame, the frame defining a first portion located above the rotation shaft and a second portion located below the rotation shaft to cause a center of gravity of the frame to be close to a center of gravity of the rotation shaft; and
an adjusting device connected between the frame and the rotation shaft to adjust the pitch angle.

2. The solar cell support assembly according to claim 1, wherein an area of the first portion is at least a quarter of that of the second portion.

3. The solar cell support assembly according to claim 2, wherein the area of the first portion is equal to that of the second portion.

4. The solar cell support assembly according to claim 1, wherein the frame comprises:
an upper beam disposed above the rotation shaft;
a lower beam disposed below the rotation shaft; and
a connecting rod connected with the upper beam and the lower beam, and pivotably connected to the rotation shaft.

5. The solar cell support assembly according to claim 4, wherein the frame comprises:
a first connecting member fixed on the rotation shaft.

6. The solar cell support assembly according to claim 5, wherein the connecting rod is pivotably connected to the first connecting member fixed on the rotation shaft.

7. The solar cell support assembly according to claim 5, wherein the frame further comprises an upper supporting bracket configured to support the upper beam and a lower supporting bracket configured to support the lower beam, and
wherein the adjusting device is connected to the upper supporting bracket and the lower supporting bracket respectively to control the pitch angle formed between the rotation shaft and the frame.

8. The solar cell support assembly according to claim 7, wherein the upper supporting bracket comprises an upper-left supporting rod, an upper-middle supporting rod and an upper-right supporting rod,
first ends of the upper-left supporting rod and the upper-right supporting rod are connected to the upper-middle supporting rod respectively,
second ends of the upper-left supporting rod and the upper-right supporting rod are connected to the upper beam,
the upper-middle supporting rod is connected to the upper beam and adjustably connected to the rotation shaft via the adjusting device, and a first end of the connecting rod is connected to the upper-middle supporting rod;
wherein the lower supporting bracket comprises a lower-left supporting rod, a lower-middle supporting rod and a lower-right supporting rod,
first ends of the lower-left supporting rod and the lower-right supporting rod are connected to the lower-middle supporting rod respectively,
second ends of the lower-left supporting rod and the other end of the lower-right supporting rod are connected to the lower beam, and
the lower-middle supporting rod is connected to the lower beam and adjustably connected to the rotation shaft via the adjusting device, and a second end of the connecting rod is connected to the lower-middle supporting rod.

9. The solar cell support assembly according to claim 8, wherein the adjusting device comprises:
first and second connecting pieces disposed on the upper-middle supporting rod and spaced with each other in a length direction of the upper-middle supporting rod;
a first adjusting member connected to the rotation shaft and at least one of the first and second connecting pieces to adjust the pitch angle formed between the rotation shaft and the frame; and
a second adjusting member connected to the rotation shaft and to the lower-middle supporting rod adjustably so as to adapt to a change of the pitch angle formed between the rotation shaft and the frame.

10. The solar cell support assembly according to claim 9, wherein each of the first and second connecting members is configured as a U-shaped bolt, and the rotation shaft passes through the first and second connecting members respectively.

11. The solar cell support assembly according to claim 1, wherein the frame comprises:
an upper beam disposed above the rotation shaft;
an upper supporting bracket connected to the upper beam and pivotably connected to the rotation shaft via the adjusting device to adjust the pitch angle formed between the rotation shaft and the frame;
a second connecting member fixed on the rotation shaft;
a middle beam disposed above the rotation shaft and pivotably connected to the second connecting member;
a lower supporting bracket pivotably connected to the second connecting member; and
a lower beam disposed below the rotation shaft and connected to the lower supporting bracket.

12. The solar cell support assembly according to claim 11, wherein the upper supporting bracket comprises an upper-left supporting rod, an upper-middle supporting rod and an upper-right supporting rod,
first ends of the upper-left supporting rod and the upper-right supporting rod are connected to the upper-middle supporting rod respectively,
second ends of the upper-left supporting rod and the upper-right supporting rod are connected to the upper beam,
the upper-middle supporting rod is adjustably connected to the rotation shaft via the adjusting device.

13. The solar cell support assembly according to claim 12, wherein:
a first connecting hole and a second connecting hole are formed in the upper-middle supporting rod and spaced with each other in a length direction of the upper-middle supporting rod, and
the adjusting device comprises a third adjusting member fixed on the rotation shaft and defining a coupling hole corresponding to one of the first and second connecting holes, and a bolt disposed in the third adjusting member via the coupling hole and connected to one of the first and second connecting holes to adjust the pitch angle formed between the rotation shaft and the frame.

14. The solar cell support assembly according to claim 13, wherein
the lower supporting bracket comprises a lower-left supporting rod, a lower-middle supporting rod and a lower-right supporting rod,
first ends of the lower-left supporting rod and the lower-right supporting rod are connected to the lower-middle supporting rod respectively, second ends of the lower-left supporting rod and the lower-right supporting rod are connected to the lower beam, and
the lower-middle supporting rod is pivotably connected to the second connecting member and connected to the lower beam.
